(19) United States
(12) Patent Application Publication
(10) Pub. No.: US 2008/0284834 A1
(43) Pub. Date: Nov. 20, 2008

(54) Ink cartridge

(75) Inventor: Cheng-Ju Lee, Taoyuan County (TW)

Correspondence Address: BIRCH STEWART KOLASCH & BIRCH, PO BOX 747, FALLS CHURCH, VA, 22040-0747, US

(73) Assignee: Qisda Corporation

(21) Appl. No.: 12/153,069

(22) Filed: May 13, 2008

(30) Foreign Application Priority Data
May 15, 2007 (TW) 96117278

(51) Int. Cl. B41J 2/175

(52) U.S. Cl. 347/87

(57) ABSTRACT

An ink cartridge has a container, an air valve, and a floating ball. The container is utilized for storing ink. The container has at least an air channel and a flow path. The air valve is disposed at the air channel for preventing the ink from being outside the container via the air channel. The floating ball has density smaller than that of the ink. As the ink in the container is below a predetermined height, the floating ball blocks the flow path permanently.

### BACKGROUND OF THE INVENTION

(1) Field of the Invention

This invention relates to an ink cartridge, and more particularly relates to an ink cartridge capable of stopping priming ink automatically as the ink cartridge is empty.

(2) Description of the Prior Art

An inkjet printer features a printing system including an ink cartridge and a print head. The ink cartridge is utilized for storing ink, and the print head is capable to reach the ink in the ink cartridge and print on a document.

Traditional disposable ink cartridge features a print head formed thereon. In contrast with the other portions of the ink cartridge, the print head is expensive but durable. The exhausted ink cartridge must be thrown away even the print head is still operational. Therefore, the design of integrated print head and ink cartridge increases the fabrication cost and results in a waste to dispose the still-operational print head. In order to solve this problem, various designs of separated print head and ink cartridge have been developed.

In the design of separated print head and ink cartridge, a pump is demanded for sucking ink from the ink cartridge and delivering through a flow path to the print head. For colorful printing, each ink cartridge is respective to a pump for sucking the specific color of ink and delivering the ink to an ink reservoir. The print head reaches the ink reservoir to access the colorful ink and prints on a document.

Utilization rate of ink cartridge of different colors are usually different. The most popular ink cartridge is exhausted first. In order to prevent the pump from sucking the exhausted ink cartridge to damage the print head and prevent the color of the ink drop released from the print head from having any mistake, the ink cartridge usually needs an additional detector for sensing whether the ink cartridge is empty or not. Once the ink cartridge is empty, the detector announces the user to replace the empty ink cartridge.

However, the additional detector in the ink cartridge or the usage of multiple pumps for colorful printing is costly. Therefore, it is eager for the person in the art to skip the detector and use single pump for colorful printing with the above mentioned problems being resolved.

### SUMMARY OF THE INVENTION

It is an object of the present invention to skip the detector in the ink cartridge so as to reduce the fabrication cost.

It is another object of the present invention to provide an ink cartridge adapted to the design of using single pump for colorful printing, and the ink cartridge is capable to prevent the print head from being damaged.

The ink cartridge provided in the present invention has a container, an air valve, and a floating ball. The container is utilized for storing ink and has at least an air channel and a flow path. The air valve is disposed at the air channel for preventing the ink in the container from being outside the container via the air channel. Density of the floating ball is smaller than that of the ink. As the ink in the container is below a predetermined height, the floating ball blocks the flow path therebelow.

By using the above mentioned ink cartridge, an ink ejection system is also provided in the present invention. The ink ejection system has at least an above mentioned ink cartridge, an ink station, and at least a pump. Wherein, the ink station is utilized for carrying the ink cartridge. The ink station has at least a tunnel for connecting to the flow path of the ink cartridge. As the ink cartridge is positioned on the ink station, the flow path is connected to the tunnel. The pump is utilized for priming the ink in the container through the tunnel to a reservoir for a print head to print.

### BRIEF DESCRIPTION OF THE DRAWINGS

The present invention will now be specified with reference to its preferred embodiment illustrated in the drawings, in which:

FIG. 1 is a schematic cross-section view of a preferred embodiment of the ink cartridge in the present invention;

FIG. 2 is an enlarged cross-section view of the valve body of the ink valve in FIG. 1;

FIG. 3 is a schematic cross-section view of the ink cartridge in the present invention being positioned on the ink station;

FIG. 4 is a schematic cross-section view of an empty ink cartridge in the present invention as the ink cartridge is empty; and

FIG. 5 is a schematic view of a preferred embodiment of the ink ejection system in the present invention.

### DESCRIPTION OF THE PREFERRED EMBODIMENT

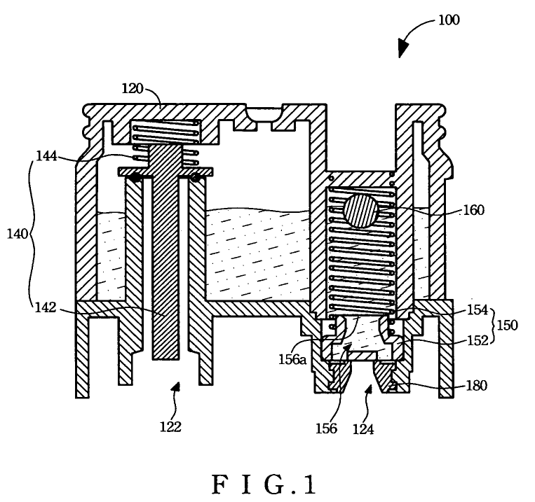

FIG. 1 shows a cross-section view of a preferred embodiment of an ink cartridge 100 in the present invention. As shown, the ink cartridge 100 has a container 120, an air valve 140, and a floating ball 160. The container 120 is utilized for storing ink and has an air channel 122 and a flow path 124 thereon. The air valve 140 is disposed at the air channel 122 for preventing the ink within the container 120 from being outside the container 120 via the air channel 122. The air valve 140 has a valve body 142 and a spring 144. The valve body 142 is disposed at the air channel 122. The spring 144 is located between the valve body 142 and the sidewall of the container 120. As the air valve 140 is opened, the valve body 142 moves upward to compress the spring 144 and a respective elastic recovery force is generated by the compressed spring 144 for driving the valve body 142 to close the air channel 122.

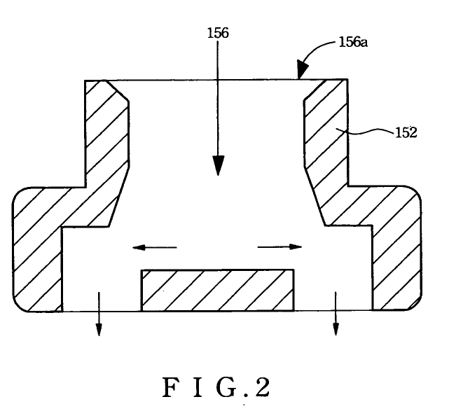

An ink valve 150 is disposed at the flow path 124 to control the ink flow in the ink cartridge 100. The ink valve 150 has a valve body 152 and a spring 154. The valve body 152 is disposed at the flow path 124. The spring 154 is located between the valve body 152 and the sidewall of the container 120. The spring 154 is utilized for generating an elastic recovery force driving the valve body 152 to close the flow path 124. Also referring to FIG. 2, the valve body 152 has an ink path 156 as a ink flowing path crossing the container 120. As shown in FIG. 1, before the ink cartridge 100 is positioned on an ink station (not shown in this figure), the spring 154 generate a force driving the valve body 152 downward so as to have the valve body 152 firmly sealed to a water proofing plastic ring 180. Meanwhile, the ink path 156 within the valve body 152 is also blocked by the water proofing plastic ring 180.

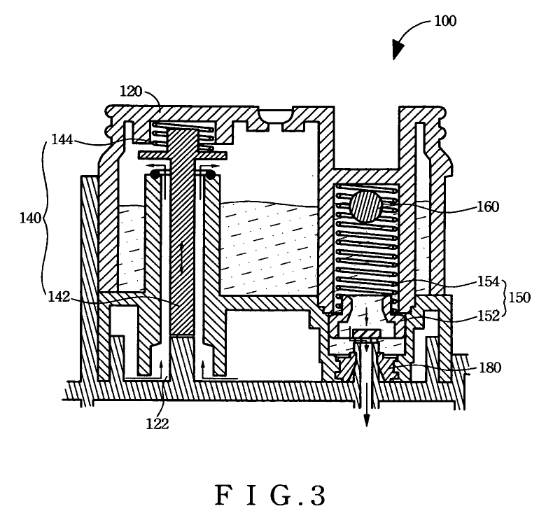

Referring to FIG. 3, as the ink cartridge is positioned on the ink station (not shown in this figure), the valve body 152 is pushed upward to open the ink valve 150 and the ink in the ink cartridge 100 is able to flow through the ink path 156 of the valve body 152 to outside the container 120. That is, the ink cartridge 100 is capable for supplying ink.

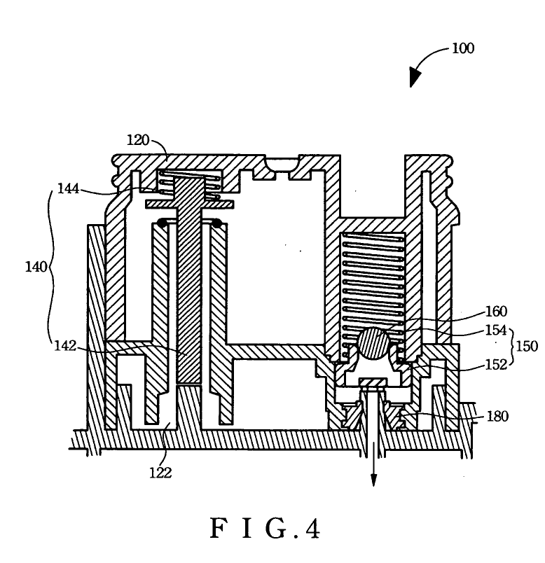

As the ink cartridge 100 is capable for supplying ink, a pump (not shown in this figure) is connected to the flow path 124 to keep the interior of the container 120 negative pressure to drive the ink flowing outward. As shown in FIG. 3, it is noted that the density of the floating ball 160 is smaller than that of the ink to make sure that the floating ball 160 remains on the top surface of the ink so as to keep the ink path 156 open as the ink cartridge is not exhausted. Whereas, as shown in FIG. 4, as the level of the ink within the container 120 is below a predetermined height, the weight of the floating ball 160 or the force due to the difference of air pressure between the outlet of the flow path 124 and the interior of the container 120 drives the floating ball 160 downward to block the inlet 156a of the ink path 156. Thus, the flow path 124 is closed. It is noted that the diameter of the floating ball 160 should be greater than that of the inlet of the ink path 156 for effectively blocking the ink path 156.

In addition, in order to prevent the floating ball 160 from leaving the ink path 156 when refilling ink in the container 120, the floating ball 160 should be formed of soft material and possess enough weight, or the pump may provide sufficient force driving the floating ball jammed in the ink path 156, so as to generate enough force between the floating ball 160 and the ink path 156. Thereby, the floating ball 160 may permanently block the ink path 124.

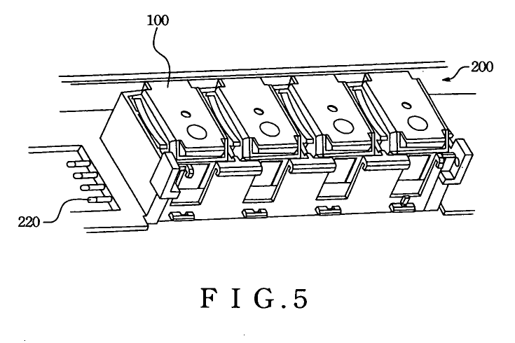

FIG. 5 shows a schematic view of a preferred embodiment of ink ejection system in the present invention. As shown, the ink ejection system has at least one ink cartridge 100 (four ink cartridges 100 are shown in this figure), an ink station 200, and at least a pump (not shown). Wherein, the ink station 200 is utilized for carrying the ink cartridges 100. Also referring to FIG. 3, as the ink cartridge 100 is positioned on the ink station 200, the ink valve 150 of the ink cartridge 100 is opened and the ink starts to supply. The ink station 200 has at least a tunnel 220 (four tunnels 220 connecting to the four ink cartridges 100 are shown in this figure) respective to the flow path 124 of the ink cartridge 100. As the ink cartridge 100 is positioned on the ink station 200, the flow path 124 is connected to the tunnel 220. Then, the pump primes the ink in the container 120 through the tunnel 220 to a reservoir for a print head to print on a document.

The ink ejection system of FIG. 5 can be adapted to the design of multiple pumps to prime colorful ink. That is, each ink cartridge 100 is respective to a pump. Each pump primes specific color of ink in the respective ink cartridge 100 through the respective tunnel 220 and the respective flow path 124 independently. However, the usage of multiple pump should not be a limitation to the present invention. The ink ejection system of the present invention is also suitable to the design of using single pump to prime ink.

The consumption rate of ink with different colors is different. When using single pump to prime ink, the pump prefers to prime the empty ink cartridge, which is usually the most popular ink cartridge, because the empty ink cartridge has the smallest flow resistance. As a result, the ink ejection system fails to supply ink to the print head because the pump cannot prime the remaining ink in the other ink cartridges to the reservoir, which may damage the print head.

In contrast, in the present embodiment, because the floating ball 160 blocks the ink path 156 of the empty ink cartridge 100, the pump must prime the ink cartridges 100 with remaining ink. Therefore, the problem that the ink ejection system fails to supply ink to the print head cannot be happened.

In addition, in order to announce the user that the empty ink cartridge should be replaced, a detector should assembled on the ink cartridge to detect the level of the ink or simply using software to estimate ink consumption rate. Although the method of estimating ink consumption by using software skipping the detector is helpful for reducing the fabrication cost of ink cartridge 100, using software to estimate lifetime of the ink cartridge 100 cannot prevent estimating errors. It is possible that the ink cartridge was exhausted before the estimated lifetime is reached, which may damage the print head. However, the ink cartridge 100 provided in the present invention is capable to prevent the damage of the print head. Thus, it is helpful for diminishing the unfavorable problem when using software to estimate ink cartridge lifetime.

In addition, since the floating ball 160 is firmly attached to the ink path 156 as the ink cartridge 100 is empty, the refilling process of the ink cartridge 100 cannot releases the floating ball 160. Thus, the ink cartridge 100 provided in the present invention is able to prevent users from using unqualified ink, which may damage the ink ejection system and the print head.

While the preferred embodiments of the present invention have been set forth for the purpose of disclosure, modifications of the disclosed embodiments of the present invention as well as other embodiments thereof may occur to those skilled in the art. Accordingly, the appended claims are intended to cover all embodiments which do not depart from the spirit and scope of the present invention.

I claim:

1. An ink cartridge, comprising:
a container, utilized for storing ink, and having an air channel and a flow path;
an air valve, disposed at the air channel, preventing the ink from being outside the container via the air channel; and
a floating ball, having smaller density than that of the ink, and blocking the flow path as the ink being below a predetermined height.

2. The ink cartridge of claim 1, further comprising an ink valve, disposed at the flow path for controlling the ink, and the ink valve comprising:
a valve body; and
a spring, located between the valve body and the container, for driving the valve body closing the flow path;
wherein the ink valve opened when the ink cartridge is positioned on an ink station.

3. The ink cartridge of claim 2, wherein the valve body has an ink path, as the ink within the container is below the predetermined height, the floating ball blocks an inlet of the ink path.

4. The ink cartridge of claim 3, wherein a diameter of the floating ball is greater than a diameter of the inlet of the ink path.

5. The ink cartridge of claim 1, wherein the flow path is connected to a pump for keeping the container negative pressure.

6. The ink cartridge of claim 1, wherein as a level of the ink within the container is below the predetermined height, the floating ball permanently blocks the flow path.

7. The ink cartridge of claim 1, wherein the air valve comprising:
a valve body; and
a spring, located between the valve body and the container, for driving the valve body to block the air channel.

8. An ink ejection system, comprising:
an ink cartridge, comprising:
a container, utilized for storing ink, and having an air channel and a flow path;
an air valve, disposed at the air channel for preventing the ink from being outside the container via the air channel; and
a floating ball, having density smaller than that of the ink, and blocking the flow path as the ink being below a predetermined height; and
an ink station, utilized for carrying the ink cartridge, and having a tunnel utilized for connecting to the flow path; and
a pump, utilized for priming the ink within the container through the tunnel to a reservoir for a print head to print.

9. The ink ejection system of claim 8, further comprising an ink valve disposed at the flow path for controlling ink flow.

10. The ink ejection system of claim 9, wherein the ink valve comprising:
a valve body; and
a spring, located between the valve body and the container, for driving the valve body closing the flow path;
wherein the ink valve opened when the ink cartridge is positioned on the ink station.

11. The ink ejection system of claim 10, wherein the valve body has an ink path, as a level of the ink within the container is below a predetermined height, the floating ball blocks an inlet of the ink path.

12. The ink ejection system of claim 11, wherein a diameter of the floating ball is greater than a diameter of the inlet of the ink path.

13. The ink ejection system of claim 8, wherein the air valve comprising:
a valve body; and
a spring, located between the valve body and the container, for driving the valve body to block the air channel.

14. The ink ejection system of claim 8, wherein the pump primes the ink of each of the ink cartridges through the tunnel.

15. The ink ejection system of claim 8, wherein each ink cartridge has a respective pump, which primes ink of the ink cartridge through the respective tunnel and the respective flow path.

16. A method for priming ink of an ink cartridge, the ink cartridge having a container with an air channel and a flow path thereon, and a pump priming the ink within the container through the flow path, the method comprising the steps of:
disposing a floating ball in the container, and the floating ball having density smaller than that of the ink; and
as a level of the ink within the container being below a predetermined height, the floating ball blocking the flow path therebelow.

17. The method of claim 16, further comprising the step of disposing an ink valve on the flow path for controlling the ink flow, the ink valve has an ink path, and as the level of ink is below the predetermined height, the floating ball blocks an inlet of the ink path.

18. The method of claim 16, wherein the floating ball permanently blocks the flow path.
